(19) United States
(12) Patent Application Publication
(10) Pub. No.: US 2023/0138346 A1
(43) Pub. Date: May 4, 2023

(54) MANAGING FILE DEPENDENCY MANAGEMENT IN VIRTUAL MACHINES

(71) Applicant: HEWLETT-PACKARD DEVELOPMENT COMPANY, L.P., SPRING, TX (US)

(72) Inventors: RATNESH KUMAR LOCKTON, CAMBRIDGE (GB); VIVEK SRIVASTAVA, CAMBRIDGE (GB)

(21) Appl. No.: 17/996,149

(22) PCT Filed: Apr. 28, 2020
(86) PCT No.: PCT/US20/30201

§ 371 Date: Oct. 13, 2022

(51) Int. Cl. G06F 21/53; G06F 9/455; G06F 21/56

(52) U.S. Cl. CPC G06F 21/53; G06F 9/45558; G06F 21/566; G06F 2009/45587; G06F 2221/034

(57) ABSTRACT

A computing device comprises a memory to store a first untrusted file and a second untrusted file; and a processor to scan a file system operation executing on the computing device; create an association between the first untrusted file and the second untrusted file based on the scanning; execute the first untrusted file together with the associated second untrusted file in a micro virtual machine (VM); and identify a malicious behavior of the executed first untrusted file interacting with the associated second untrusted file in the micro VM.

### BACKGROUND

A lightweight virtual machine, called micro virtual machine (VM), is a virtual machine program that serves to isolate an untrusted computing operation from a computing systems host operating system,

### BRIEF DESCRIPTION OF DRAWINGS

In the following, a detailed description of various examples is given with reference to the figures. The figures show schematic illustrations of

FIG. 1a: A computing device to identify a malicious behavior in a micro VM according to an example.

FIG. 1b: A computing device to identify a malicious behavior in a micro VM according to another example.

FIG. 2: A non-transitory computer readable medium comprising instructions for identifying a malicious behavior in a micro VM according to another example.

FIG. 3: A computing device to identify an execution of an unrelated task in relation to an untrusted file in accordance with yet another example.

FIG. 4: A method for addition of associations into metadata of untrusted files according to another example.

FIG. 5: A method for extraction of files from an untrusted archive file according to yet another example.

FIG. 6: A method for redirecting an execution operation of an untrusted file together with an associated file to a micro VM according to an example.

FIG. 7: A method for launching an entrusted file together with a further untrusted file in a micro VM according to another example.

FIG. 8a: Metadata of an untrusted file according to an example.

FIG. 8b: Metadata of an untrusted file according to another example.

FIG. 9: A method for scanning a file system operation and updating metadata of untrusted files according to yet another example.

FIG. 10: A method for detecting a file system operation and updating metadata of an untrusted file according to another example.

### DETAILED DESCRIPTION

Micro virtual machines use virtualization based security mechanisms to contain any adversaries. These micro VMs mimic how a host system would behave if it were comprised by a malicious behavior, but denies adversaries access to the host system and therefore maintains the host system integrity. By default, a micro VM assumes that all files on a computing system are to be untrusted. When a user launches an untrusted file, the host system redirects the untrusted file to be opened in a micro VM so that the activities of the untrusted file are contained and isolated from the host system. The micro VM can then decide, based on the activities of the untrusted file within the micro VM, whether the untrusted file is malicious or not.

Computing devices and non-transitory computer-readable storage media to identity a malicious behavior by executing a first untrusted file together with a second untrusted file in a micro VM are described below with reference to some examples shown in the figures.

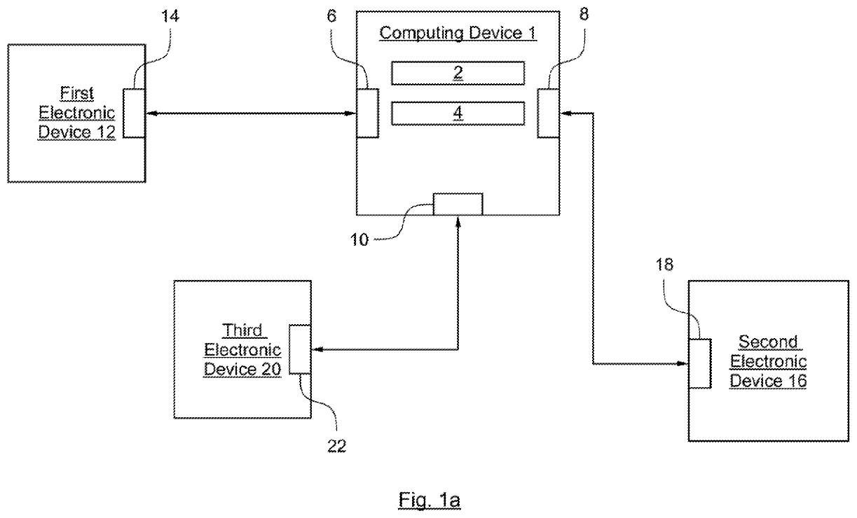

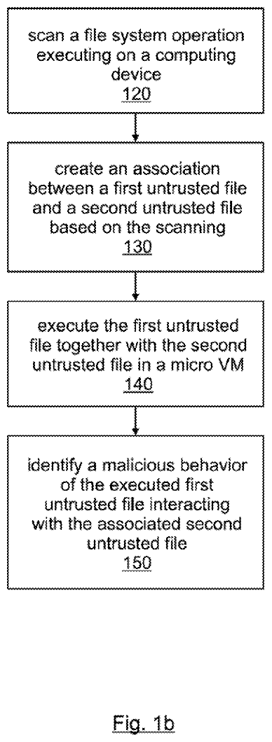

FIG. 1a illustrates a computing device t to identify a malicious behavior in a micro VM according to an example. Computing device 1 may be, for example, a notebook computer, a desktop computer, an all-in-one system, a tablet computing device, a mobile phone, an electronic book reader, or any other electronic device suitable to identify a malicious behavior in a micro VM executing on the electronic device. Computing device 1 may include a processor 2 and a computer-readable storage medium 4 to control operations of computing device 1 and/or electronic devices connected to computing device 1. Computing device 1 may also include a first communication interface 6, a universal serial bus (USB) interface 8, and a second communication interface to. USB interface 8 may implement at least one type of the USB protocol. For example, the USB protocol may be USB 1.x, USB 2.0, USB 3.0, USB 3.1, USB Type-C, etc.

Communication interfaces 6 and 10 may be a device or circuit to enable computing device to communicate with another electronic device. In some examples, communication interface 6 may be a wireless interface implementing the Bluetooth protocol. In sonic examples, communication interface 6 may be a hardware connector implementing at least one type of the USB protocol, such as USB 2.0, USB 3.0, USB 3.1, USB Type-C, etc. Communication interface to may be a display interface implementing a DisplayPort interface, a high-definition multimedia interface (HDMI), or any other interface suitable for communication with a display device.

During operation, computing device 1 and first electronic device 12 may be connected via first communication interface 6 and a communication interface 14 of first electronic device 12. Communication interface 14 may be compatible with first communication interface 6. For example, communication interfaces 6 and 14 may implement the same communication protocol.

Computing device 1 and a second electronic device 16 may be connected via UST interface 8 and a USB interface 18 of second electronic device 16. USB interface 18 may be compatible with USB interface 8. Computing device 1 and a third electronic device 20 may be connected via second communication interface 10 and a communication interface 22 of third electric device 20. communication interface 22 may be compatible with second communication interface

FIG. 1b depicts a computing device to identify a malicious behavior in a micro VM according to another example. Therein, the computing device may comprise a memory, such as memory 4 of FIG. 1a, to store a first untrusted file and a second untrusted file. The computing device may furthermore comprise a processor, such as processor 2 of FIG. 1a, wherein the processor is to execute the operations of the FIG. 1b.

The processor may scan a file system operation executing on the computing system, at 120. The processor may further create an association between the first untrusted file and the second untrusted file based on the scanning at 130. The processor may furthermore execute the first untrusted file together with the second untrusted file in a micro VM at 140. In addition, the processor may identify a malicious behavior of the executed first untrusted file interacting with the associated second untrusted file in the micro VM rut 150.

An untrusted file may be a file which is stored in the memory of the computing device by either an untrusted process or from an untrusted source. An entrusted process may, for example, be any process or service which stores files in the memory of the computing device without the computing device being directly connected with the source from where the file was delivered to the computing device. An untrusted process may, for example, be storing a file in the memory of the computing, device received by using an email program. An untrusted source may be, for example, any external source from the computing device which the computing device is directly connected to. For example, an untrusted source may be any external universal serial bus (USB) or hard disk (HD) device or network share. Further, an untrusted process may also be extracting files from an untrusted archive file, which was stored in the memory of the computing device by an untrusted process or from an untrusted source.

Identifying a malicious behavior in a micro VM as in the present example may be evoked when a file from an untrusted process or from an untrusted source is stored in the memory of the computing device. The computing device may be able to detect that a file is stored in the memory of the computing device by an untrusted process or from an untrusted source. When the computing device 1dentifies that a file is stored in the memory of the computing device via an untrusted process or from an untrusted source the file may be marked as untrusted.

When an untrusted file is stored in the Memory of the computing device either by an untrusted process or from an untrusted source, a file system operation may be executed on the computing device, Based on scanning of a file system operation at 120, the processor may create an association between a first untrusted file and a second untrusted file at 130. Since an executed file system operation is not limited to one file, more than one file may be stored on the computing device under execution of the same file system operation. For example, an untrusted archive file may, contain a first file and a second file. When a file system operation to extract the files from the archive file is executed, the computing device may scan this file system operation at 120 and the first and the second file are stored in the memory of the computing device. Since the first and the second file are from an entrusted source, they are both marked as untrusted by the computing device. Further, since the first untrusted file and the second untrusted file were both extracted and stored by the same file system operation, the computing device can create an association between the first untrusted file and the second untrusted file at 130 based on the scanned file system operation to extract these tiles from the untrusted archive.

The processor may further execute the first untrusted file together with the associated second untrusted file in a micro VM at 140. When the first untrusted file is to be executed, the computing device may check if the created association contains any associated file for the first untrusted tile. The processor may identify that the second untrusted file is an associated file in relation to the first untrusted file and therefore execute both, the first untrusted file and the. second untrusted file in a micro VM.

When the first untrusted file is executed together with the associated second untrusted file in the micro VM. the processor may identify a malicious behavior of the executed first untrusted file interacting with the associated second untrusted file in the micro VM at 150. in case the micro VM identifies a malicious behavior at 150, the processor may stop the execution and close the micro VM and dispose execution of the first and/or second untrusted file so that the first untrusted file and/or the second untrusted file may not be able to be reopened or reused. The first untrusted file and the second untrusted tile may remain stored in the memory of the computing device.

A micro VM as used in this disclosure may be an isolation technology, which uses virtualization-based security mechanisms to contain any adversaries from the computing device. Further, such a micro VM may be further designed to protect computers from malicious code execution initiated by an end user by isolating the execution of the untrusted files from the computing device. The micro VM may further be able to virtualize hardware components of the computing device and to mimic the configuration of the computing device for a specific task. Therein, the micro VM may have a different kernel than an underlying operating system of the computing device.

The virtualization of the hardware of the computing device may be achieved by a late-load hypervisor, called a microvisor. The microvisor may be similar in concept to a hypervisor that is installed on a server or desktops operating system. VMs, as opposed to micro VMs, are full versions of an operating system with full suites of applications, whereas the microvisor may use the hardware virtualization present on desktop processors to create micro VMs which are specialized virtual machines tailored to support a specific task.

These specialized virtual machines may be referred to as micro VMs and may be tailored to mimic the configuration of the computing device for a specific task. When a file system operation is executed on the computing device for example to open a file for text editing, perform an installation process, extract files from an archive file, or to download a file from an email attachment, the microvisor may create a micro VM tailored to that specific task, meaning that the micro VM may have resources dedicated to perform the task but no further resources. By placing vulnerable tasks into a micro VM, the malicious behavior may not be able to attack the computing device. When a malicious behavior is identified 150, the micro VM may be closed and disposed, so that the first and/or second untrusted file may not be able to be reopened or reused.

Scanning the file system operations may include intercepting shell commands, intercepting Application Programming interfaces (APIs), intercepting kernel mode operations of the computing device, or a combination thereof. For example, intercepting shell commands may for example include reading and analyzing a call stack of the computing system or halting shell commands with a trap or stop function to read and analyze the command. Intercepting kernel mode operations may be similar to intercepting shell commands but for the special case of reading and analyzing commands executed in administrator or kernel mode on the computing device. Intercepting APIs may include reading and analyzing logs of network protocols used on the computing device and reading and analyzing performed HTTP requests.

A file system operation may include a copy operation, a paste operation, a move operation, or a combination thereof. A copy operation may be an operation where a file is being copied into one of a buffer, a temporary storage, a fast memory, a cache, or a combination thereof. A paste operation may be an operation where a file which has been copied into one of a buffer, a temporary storage, a fast memory, or a cache, is pasted on the computing device. A move file operation may be an operation where a file is being moved from one directory or source on the computing device 1nto another directory or source on the computing device.

The processor of the computing device may further maintain the association between the first untrusted file and the second untrusted file when scanning a second file system operation executing on the computing device. For example, when either the first untrusted file or the second untrusted file is moved to a different directory or source on the computing device, the processor may detect this file system operation and scan the file system operation. Based on the scanned second file system operation the processor may update the present association accordingly by updating the association with the new source of the moved untrusted file on the computing device. Now, when the first untrusted file is to be executed, the processor may remain able to find the second untrusted file although the source or directory on the computing device has changed and may remain able to execute the first untrusted file together with the second untrusted file in a micro VM. This enables the computing device to remain in full capability to identify a malicious behavior even if untrusted tiles are moved, copied, pasted or amended in any other way.

The file system operation may be assigned a globally unique instance identifier (GUID), wherein an association between the first untrusted file and the second untrusted file may be associated with the GUID. For example, when a file system operation is executed on the computing device, the entrusted files involved in the file system operation may get assigned a GUID which points to the file system operation. Furthermore, one. GUID may identify copy operations, whereas a different GUID may identify move operations. These GUIDs may, in a further example, be grouped for a specific untrusted file. This provides that alt GUIDs and thus all file system operations which have been executed on the specific untrusted file can be traced.

Further, the association between the first untrusted file and the second untrusted file may be stored in a metadata portion of the first untrusted file and in a metadata portion of the second untrusted file. The association may comprise the information that the first untrusted file is associated to the second untrusted and that the second entrusted file is associated with the first untrusted file. Further, the association may comprise information of the source or directory of each of the untrusted files. The information, that the first untrusted file is associated with the second untrusted file may be stored in a portion of metadata of the first untrusted file. The information that the second untrusted file is associated with the first untrusted file may likewise. be stored in the metadata portion of the second untrusted When, for example; the first untrusted file is executed, the processor may discover that the second untrusted file. is associated with the first untrusted file by reading the association information which is stored in the metadata portion of the first untrusted file. Based on the information read from the portion of the metadata of the first untrusted file, the processor may be able to execute the first untrusted file together with the associated second file in a micro VM.

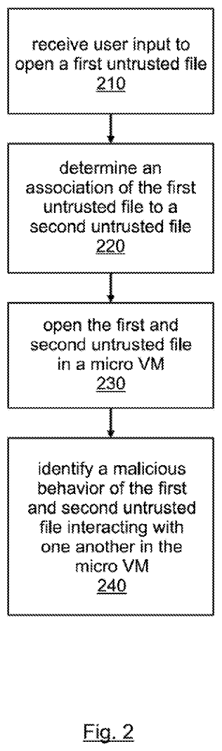

FIG. 2 depicts a non-transitory computer readable medium comprising instructions for identifying a malicious behavior in a micro VM according to another example. Therein, the non-transitory computer-readable storage medium may comprise instructions, which when executed by a processor of a computer, cause the processor to perform the operations of FIG. 2.

Specifically, the processor may be caused to receive user input to open a first untrusted file at 210. Further, the processor may be caused to determine an association of the first untrusted file to a second untrusted file at 220. The processor of the computer may be furthermore caused to open the first and second untrusted file in a micro VM at 230. Lastly, the processor may be caused to identify a malicious behavior of the first untrusted file and the second untrusted file interacting with one another in the micro VM at 240.

A received user input 210 may be an input from the user of the computer such as by using an input device such as a keyboard, a mouse, or a touchpad. Further, the received user input to open a first untrusted file may be a received double-clicking event or an enter-space event via an input device which may cause the untrusted file to be opened and to perform a configured task. Therein, the configured task may be for example an installation task, a displaying text task (e.g. for editing), a file system operation as described above, a task to execute an application or a program, a task to execute source code from the entrusted file, or a combination thereof.

Determining an association of the first untrusted file to the second untrusted file at 220 may comprise, for example, scanning a file system operation executing on the computing device, when the first untrusted file is stored on the computer. Therein, scanning a file system operation may include, as set forth above, intercepting shell commands, intercepting APIs, intercepting kernel mode operations of the computing device, or a combination thereof. Furthermore, a file system operation may include a copy operation, a paste operation, a move operation, or a combination thereof. When a file system operation is scanned by the processor, a QUID may be assigned to the scanned file system operation. The association between the first untrusted file and the second untrusted file may be stored in a metadata portion of the first untrusted file and in a metadata portion of the second untrusted file.

The processor may be caused to open the first untrusted file together with the second untrusted file in a micro VM at 230. When a user input is received to open the first untrusted file, a micro VM may be opened which is able to virtualize hardware components of the computer by using a hypervisor technology as described above. Further, the opened micro VM may be able to mimic the configuration of the computer for a specific task and to isolate adversaries from the computer. Since the first untrusted file is untrusted by the computer, the first untrusted file may potentially show a malicious behavior. In order to isolate the potentially malicious behavior from the computer the first untrusted file may be opened in the micro VM. Further, based on the determined association between the first untrusted file to the second untrusted file at 220, the processor may be able to retrieve the second untrusted file and to open the first and the second untrusted file in the same micro VM at 230.

The processor may further be caused to idea* a malicious behavior of the first and second untrusted file interacting with one another in the micro VM at 240. A malicious behavior may be identified, for example, when the first untrusted file performs an unusual task. For example, the first untrusted file may perform a task which is not intended to be performed, or aside from performing the intended task cause the second untrusted file to perform a task which was not intended to be performed, or both the first untrusted file and the second tint-rusted file perform a task which was not intended.

A malicious behavior may comprise an unintended execution of an unrelated task in relation to the first untrusted file, the second untrusted tile, or a combination thereof. For example an unrelated task may be that when the first untrusted file is intended to perform an installation process but instead tries to overuse CPU power by applying a cryptographic function. Further, the first untrusted file may perform its considered task, for example an installation task, but may evoke the second untrusted file to perform an unrelated task such as overusing CPU power by applying a cryptographic function or to connect to an untrusted source. Further, both the first untrusted and the second untrusted file may in combination perform an unrelated task. For example, the first entrusted file may be considered to perform an installation task but overuses CPU power by applying a cryptographic function and further evokes the second untrusted file to connect to an untrusted source to provide the result of the unintended task of the first untrusted file to the untrusted source.

Specifically, a malicious behavior may comprise attempting to perform unauthorized changes to software, folders, files and/or registry entries of the computer, using disproportional high processing power in relation to the first untrusted file, the second untrusted file, or a combination thereof, connecting to an untrusted source, corrupting hardware of the computer, performing ransomware, or a combination thereof. For example, an attempt to perform unauthorized change to software may be adding source code to the software and/or deleting source code from the software. For example, an attempt to perform an unauthorized change to folders, files and/or registry entries of the. computer may be deleting and/or overwriting a folder, file and/or registry entry on the computer. An attempt for using disproportional high processing power file may occur when the first untrusted file is supposed to perform a software initialization task, but starts performing a cryptographic operation instead. An attempt to connect to an untrusted source may be an attempt to connect to a source which does not include a trusted certificate or is located in a suspicious location, e.g. having a suspicious network path. An attempt to corrupt hardware of the computer may be an attempt to overuse storage by heavily overwriting it, or causing hardware components to overheat. An attempt to perform ransomware may be an attempt to encrypt storage, a file and/or a folder on the computing device by the first untrusted tile, the second untrusted file, or a combination thereof.

The storage medium may further cause the processor to determine a source of the malicious behavior from within the first and the second untrusted file. The determination of the source of the malicious behavior may be performed by retracing from which file the malicious behavior started to occur. For example, when the first and the second untrusted file are opened in the micro VM and the first untrusted file performs a task which is unrelated to the intended task, for example the untrusted file is supposed to perform an installation task, but performs an attempt to overuse CPU processing power, the first untrusted file may he determined as being the source of the malicious behavior. In another example, when the first and the second untrusted file are opened in the micro VM and the first untrusted file begins to perform its intended task but causes the second untrusted file to perform an unintended task, the first untrusted file is the source of the malicious behavior. In another example, when the first and the second untrusted files are opened in the micro VM and the first untrusted file begins to perform an intended task together with the second untrusted file, but the second untrusted file further performs unrelated task, the second untrusted file may be determined being the source of the malicious behavior.

The storage medium may further cause the processor to reconstruct a file history of the source of the malicious behavior based on associations between the first and the second untrusted file. For example, the instructions may cause the processor to generate a notification for a user about the file history of the source of the malicious behavior. The file history may be reconstructed based on scanned file system operations. For example, the file history may be reconstructed using a GUID assigned to a file system operation as described above. Furthermore, the file history may be reconstructed based on a portion of metadata of each of the first untrusted file and the second untrusted file. Therefore, the computer may be able to reconstruct file system operations performed on the source of the malicious behavior. The reconstructed file system operations may then be output to a user of the computer.

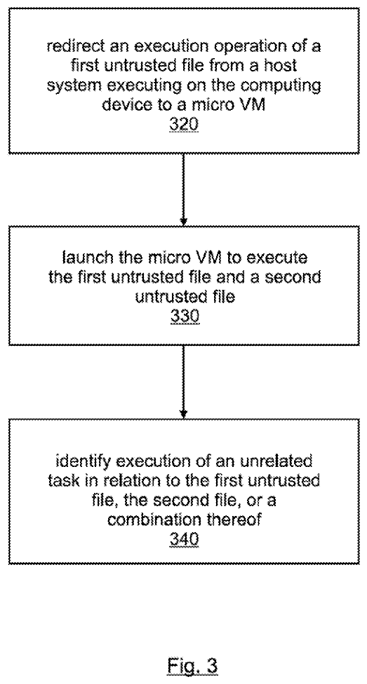

FIG. 3 depicts a computing device to identify an execution of an unrelated task in relation to an untrusted tile in accordance with another example. Therein, the computing device may comprise a memory to store a first untrusted file and a second untrusted file. The computing device may furthermore comprise a processor, wherein the processor is to execute the operations of FIG. 3.

The processor may redirect an execution operation of the first untrusted file from a host system executing on the computing device to a micro VM, at 320. The processor may be further launch the micro VM to execute the first untrusted file and the second untrusted file, at 330. Lastly, the processor may identify execution of an unrelated task in relation to the first untrusted file, the second untrusted file, or a combination thereof, at 340.

The stored first and second untrusted file may be a file which is stored in the memory of the computing device by either an untrusted process or from an untrusted source. An untrusted process may, for example, be any process or service which stores files in the memory of the computing device without the computing device being directly connected with the source from where the file was delivered to the computing device. An untrusted process may, for example, be storing a file in the memory of the computing device received by using an email program. An untrusted source may be, for example, any external source from the computing device which the computing device 1s directly connected to. For example, an untrusted source may be any external USB/I-ID device or network share. Further, an untrusted process may also be extracting files from an untrusted archive file, which was stored in the memory of the computing device by, an untrusted process or from an untrusted source.

The processor may be redirect an execution operation of the first untrusted file from a host system executing on the computing device to a micro VM, at 320. Thus, instead of being executed directly on the host system executing on the computing device, the first untrusted file is redirected to the micro VM. Therein, the micro VM may use an isolation technology to contain any adversaries form the computing device by virtualizing hardware components of the computing device as described above. Furthermore, the micro VM may mimic the configuration of the computing device for a specific task. Since the micro VM is isolated from the computing device and adversaries are contained in the micro VM, the execution operation of the first untrusted file is redirected into the micro VM, so that if a malicious behavior may occur, the malicious behavior can not affect the host system of the computing device.

The processor may be further launch the micro M to execute the first untrusted file and the second untrusted file, at 330. Therein, the micro VM may be a micro VM as described above.

Further, the processor may identify execution of an unrelated task in relation to the first untrusted file, the second untrusted file, or a combination thereof, at 340. An unrelated task may be an attempt to perform an unauthorized change to software, a folder, a file and/or a registry entry of the computing device, using disproportionally high processing power in relation to the first untrusted file, the second untrusted file, or a combination thereof, connecting to an untrusted source, corrupting hardware of the. computing device, performing ransomware, or a combination thereof. For example, an attempt to perform an unauthorized change to software may be adding source code to the software and/or deleting source code from the software, An attempt to perform an unauthorized change to folders, tiles and/or registry entries of the computing device may, for example, be deleting and/or overwriting folders, files and/or registry entries on the computing device. An attempt for using disproportionally high processing power may occur when the first untrusted the second untrusted file, or a combination thereof are supposed to perform a software installation task, but start performing a cryptographic operation instead. An attempt to connect to an untrusted source may be an attempt to connect to a source which does not include a trusted certificate or is located in a suspicious location. An attempt to corrupt hardware of the computing device may be an attempt to overuse storage by heavily overwriting it, or causing hardware components to overheat. An attempt to perform ransomware may be an attempt to encrypt storage, files and/or folders on the computing device by the first untrusted file, the second untrusted file, or a combination thereof.

Upon identifying execution of an unrelated task, the processor may dose the micro VM executing the first and second untrusted file. For example, when the micro VM identifies an unrelated task in relation to the first untrusted file, the second untrusted file, or a combination thereof, a kill chain operation may be performed which may immediately disrupt the execution task inside the micro VM from being further performed, Further, the micro VM may be closed immediately by the processor and disposed by the computing device, so that the first and/or the second untrusted file may not be able to be reopened and/or reused again.

Upon identifying execution of an unrelated task, the processor may further mark the first and second untrusted file, as not executable by the computing device. Therein, the first untrusted file and the second untrusted file may remain stored in the memory of the computing device. However, based on the identified malicious behavior, the computing device may mark the first untrusted file and the second untrusted file as not executable, for example, by blacklisting the files in a registry of the computing device.

Upon identifying no execution of an unrelated task, the processor may mark the first untrusted file as trusted. That is, when no malicious behavior is identified in the micro VM, the first untrusted file may be no longer considered as untrusted. Instead, the untrusted file may be marked as trusted file. Marking a file from untrusted to trusted may be performed by removing the untrusted file from a blacklist in a registry of the computing device. When the first untrusted file is then to be executed, no micro VM may be opened to isolate execution of the file from the computing device. Instead, the trusted file will be executed directly on the host system of the computing device.

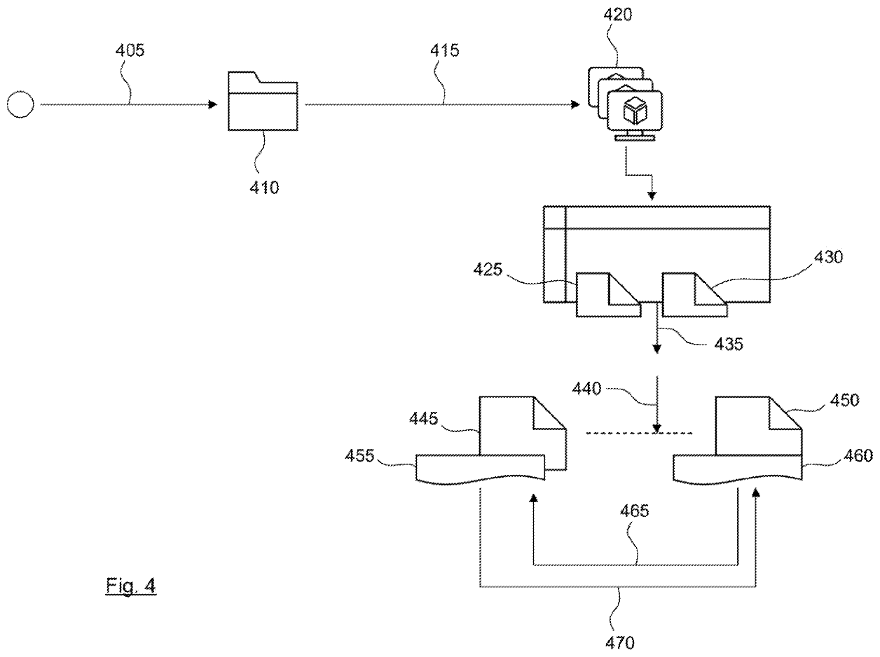

FIG. 4 depicts a method for addition of associations into metadata of untrusted files according to an example. In FIG. 4, an (untrusted archive file 410 is stored in the memory of a computing device. The untrusted archive file 410 may=be received from an untrusted process such as from an email program or from an untrusted source such as an external USB drive as described above.

The method of adding associations into metadata of untrusted files is evoked by a user input 405 to open the untrusted archive file 410. The user input 405 may be an input of the user of the computing device by using an input device such as a keyboard, a mouse, or a touchpad. The received user input to open the untrusted archive file 410 may be a received double-clicking event or an enter-space event from an input device which causes the included files clean.exe 425 and evil.dll 430 to be extracted from the untrusted archive file 410. The extracted files, namely clean.exe 425 and evil.dll 430, are categorized as entrusted by the computing device since they are included in the untrusted archive file 410.

Based on the received user input 405, the method creates 415 a micro VM 420 to isolate potential adversaries from the computing device. The micro VM 420 mimics the hardware configuration of the computing device and is tailored for the task to open the untrusted archive file 410. Therein, the kernel of the micro VM 420 may differ from the kernel of the operating system of the computing device. Specifically, the user input 405 to open the untrusted archive file 410 is redirected to the micro VM 420 by performing the task to open the untrusted archive file 410 in the micro VM 420. The task to open the untrusted archive file 410 is performed and the files clean.exe 425 and evil.dll 430 are extracted from the untrusted archive 410 within the micro VM 420. Since no malicious behavior was identified by opening the untrusted archive file 410 in the present example, the process is performed on the computing device. That is, the files clean.exe 425 and evil.dll 430 are extracted 435 from the untrusted archive 410 and stored in in the memory of the computing device as clean.exe 445 and evil.dll 450.

Furthermore, based on the user input 405 to open the untrusted archive file 410, the computing device may scan the opening operation being a file system operation and may assign the operation with a unique instance 440, such as a GUID. Specifically, the file system operation which enabled clean.exe 445 and 450 to be stored in the memory of the computing device may be scanned and assigned with GUID 440 by the computing device. Since clean.exe 445 and evil.dll 450 stem from the same file system operation, they are assigned the GUID 440 by storing the GUID in a portion of metadata 455 of clean.exe 445 and in a portion of metadata 460 of evil.dll 450. When more than one file contain the same GUID, meaning, for example, that they were stored on the computing device by the same file system operation, an association of the files having the same GUID may be maintained in a list of associated files 465, 470 being stored in the metadata portion 455, 460 of the involved files. In the specific example of FIG. 4, these associations are mutual between clean.exe 445 and evil.dll 450 since these tiles stem from the same file system operation.

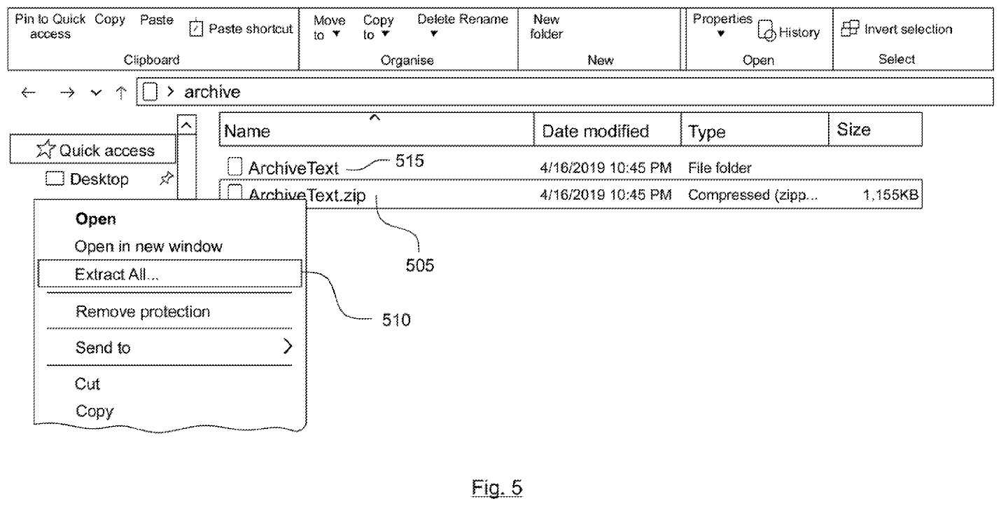

FIG. 5 depicts a method for extraction of files from an untrusted archive according to an example. Therein, an untrusted archive file 505 is stored in the memory of a computing device. When a command 510 to extract all files is executed on the untrusted archive 505, the untrusted archive file 505 is opened in a micro VM to perform the command to extract all files. In case the extraction command 510 to extract all files from the archive file 505 does not perform an unrelated task in relation to the extraction of archive tiles, the micro VM is closed and the archive file is extracted on the computing device. The extracted archive file 515 is stored in the memory of the computing device.

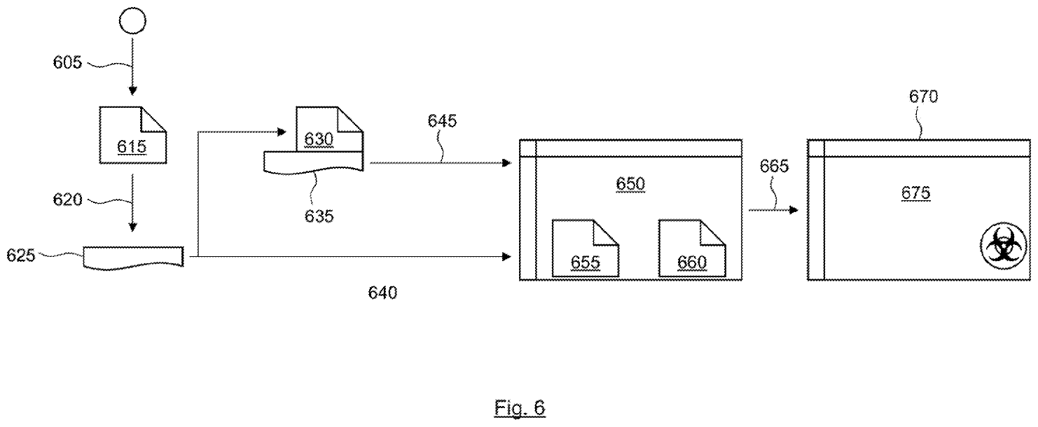

FIG. 6 depicts a method for redirecting an execution operation of an untrusted file together with an associated file to a micro VM according to an example. Therein, two untrusted files clean.exe 615 and evil.dll 630 are stored in the memory of the computing device. A user input 605 may be an input of the user of the computing device received by using an input device such as a keyboard, a mouse, or a touchpad. The received user input to execute clean.exe 615 may be a received double-clicking event or an enter-space event over an input device, which causes the computing device to execute clean.exe 615. Since clean.exe 615 is an untrusted file the processor of the computing device may open a micro VM 650 to redirect 640 execution of clean.exe 615 into the micro VM 650 and to isolate potential malicious behavior from the computing device. When performing the execution of clean.exe 615, a portion of metadata 62 of clean.exe 615 will be read 620 to retrieve a list of associated files for clean.exe 615. The processor may search for the flies in the list of associated files of clean.exe 615 and find based on the metadata 625 that evil.dll 630 is an associated file. It is to be noted that metadata 635 of the evil.dll 63o may comprise further list of associated files. In such a case, the process as described could then be reiterated for 630. The computing device will then further redirect 640 clean.exe 615 into the micro VM 650 and redirect 645 evil.dll 630 into the same micro VM 650.

The untrusted files clean.exe 615 and evil.dll 630 are redirected into the micro VM 650 so that the execution of clean.exe 655 and evil.dll 660 within the micro VM 650 may be performed without affecting the computing device. In case the micro VM discovers that clean.exe 655, evil.dll 660, or a combination thereof perform an unintended task in relation to the task of clean.exe 655. evil.dll 660 or a combination thereof, the micro VM 650 may identify 665 a malicious behavior.

An identified 665 malicious behavior by the micro VM 650 may be an attempt to perform unauthorized changes to software, folders, files and/or registry entries of the computer, using disproportionally high processing power in relation to clean.exe 655, evil.dll 660, or a combination thereof, connecting to an untrusted source, corrupting hardware of the computer, performing ransomware, or a combination thereof.

In case the micro VM identifies 665 a malicious behavior, as shown in the example of FIG. 6, the micro VM 650 may be marked as quarantined micro VM 670 comprising 675 the files clean.exe 655 and evil.dll 660.

In such a case, a notification window may be opened to notify the user that a malicious behavior was identified 665. Therein, the notification window may display the source of the malicious behavior, which in the present example would be clean.exe 655 or clean.exe 615 respectively. Further, a file history of scanned file system operations of the source of the malicious behavior may be reconstructed and provided in the notification window upon identifying 665 a malicious behavior so that the user may be able to view from which file the malicious behavior originates. Further, clean.exe 615 and evil.dll 630 may remain on the computing device but may be marked as unexecutable by the computing device.

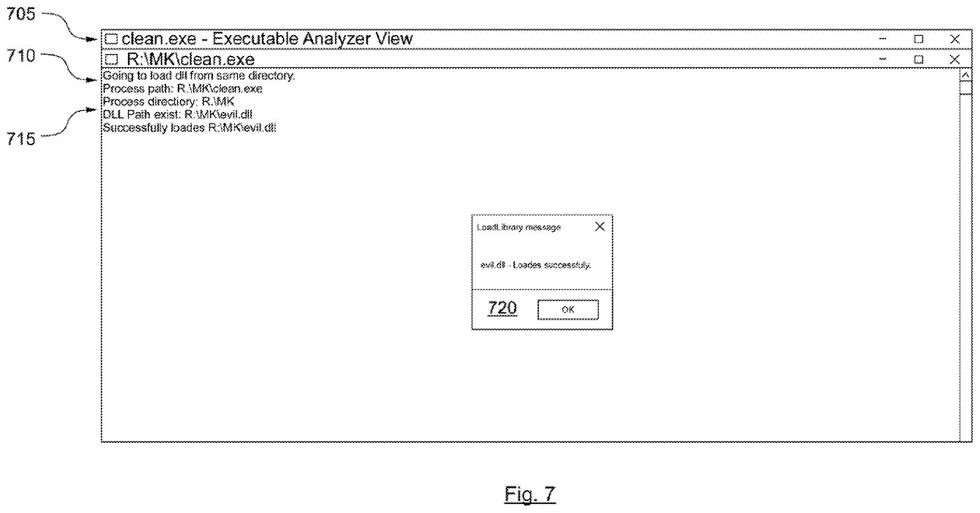

FIG. 7 shows a schematic illustration of launching an untrusted file together with a further untrusted file in a micro VM according to another example. An untrusted file clean.exe 705 is executed and loaded into a micro VM as described above. Therein, it may, be determined from a retrieved list of associated files as described before that evil.dll is associated to clean.exe 705. From the list of associated files the file directory of evil.dll is determined and a command 710 to load evil.dll into the micro VM is executed. Then, it is checked 715 if evil.dll exists in the directory determined from the list of associated files. File evil.dll is then opened in the same micro VM where clean.exe 705 is opened. When evil.dll is opened successfully in the same micro VM, the user may be notified by a notification window 720.

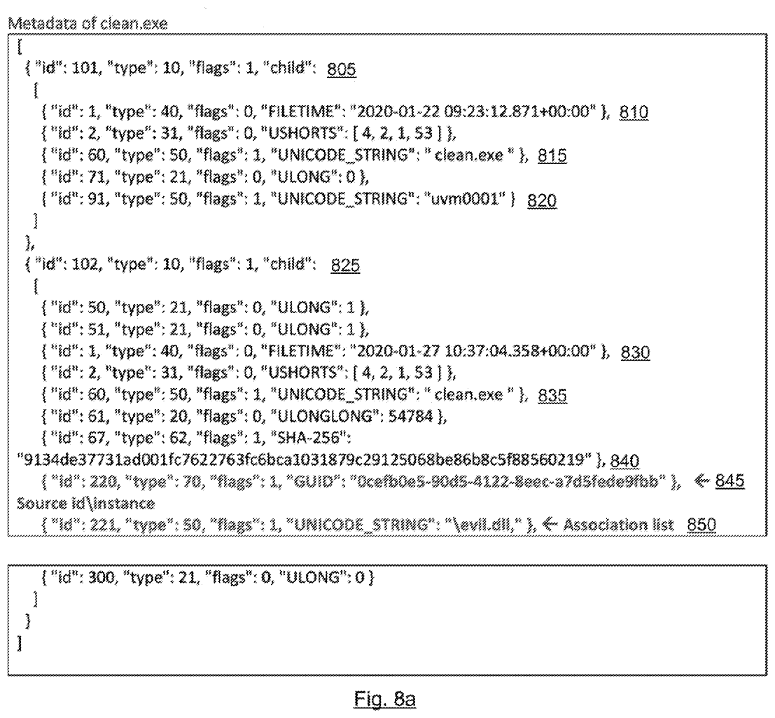

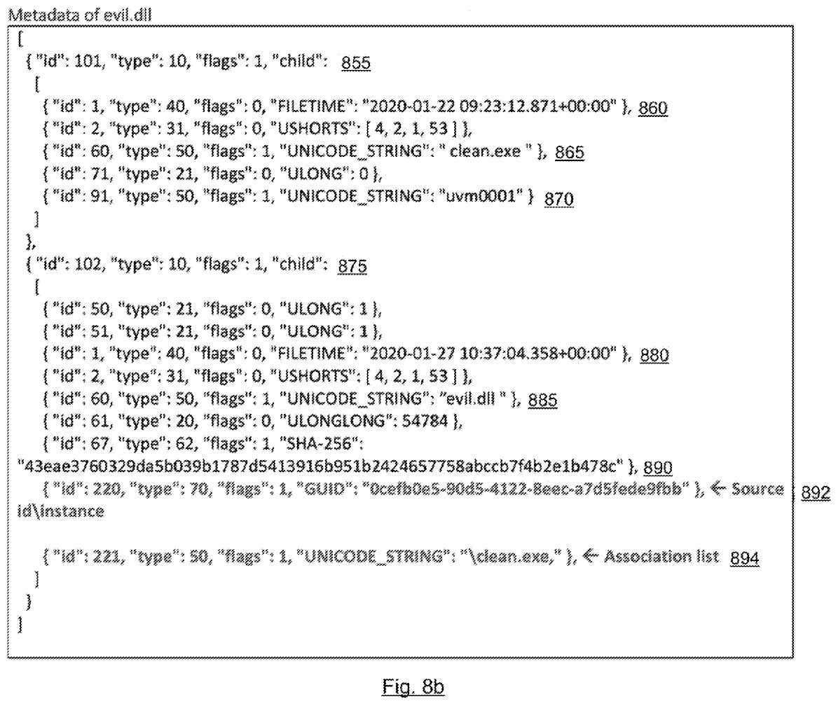

FIG. 8a depicts metadata of an untrusted file according to an example. Specifically, metadata of clean.exe according to any of the previous examples is provided in the present example. The metadata comprises header information 805 of clean.exe. The header information 805, in this specific example, includes a timestamp 810 of clean.exe being stored in the memory of the computing device, a Unicode string 815 encoding of the name of the file, and an instance ID as Unicode string 820 of the micro VM which executed clean.exe, namely the VM which extracted clean.exe on to the computing device as described above.

A further portion of the metadata of clean.exe comprises information of file system operations 825 executed for clean.exe. The file system operation information 825 may include a time stamp 830 when the file system operation was performed, the name of the file 835, and a SHA-256 encoding 840 of the file name. When a computing device scans a file system operation the computing device assigns a GUID 845 to the scanned file system operation. Since clean.exe is associated with a scanned file system operation, the GUID 845 is stored in the file system operation portion of the metadata.

Further, When the computing device determines associated files for clean.exe based on the GUID 845, the computing device creates a list of an associated file 850 and stores the associated file in the file system operation information 825 of clean.exe. This way, associations and more detailed information can be retrieved when examining the metadata portion of clean.exe.

FIG. 8b depicts metadata of an untrusted file according to an example. Specifically, the metadata of according to any of the previous examples is provided in the present example. The metadata of evil.dll comprises header information 855 of evil.dll. The header information 855, in this specific example, includes a timestamp 860 indicating when evil.dll was stored on the computing device, a Unicode string 865 encoding the name of the file, and an instance ID in Unicode string 870 of the micro VM which executed clean.exe, namely the VM which extracted clean.exe on to the computing device as described above.

Further, a portion of the metadata of evil.dll comprises information of file system operations 875 executed for evil.dll. The file system operation information 875 may include a time stamp encoding 880 of when the file system operation was performed, the name of the file 885, and a SHA-256 encoding 890 of the file name. When a computing device scans a file system operation the computing device assigns a GUID 892 to the scanned file system operation. Since evil.dll is associated with the scanned file system operation, the GUID 892 is stored in the file system operation information 875 portion of the metadata.

Further, when the computing device determines associated files for evil.dll based on the GUID 892, the computing device creates a list of associated files 894 and stores the associated files 894 in the file system operation information 875 of evil.dll. This way, associations and even more detailed information can be retrieved when examining the metadata portion of evil.dll.

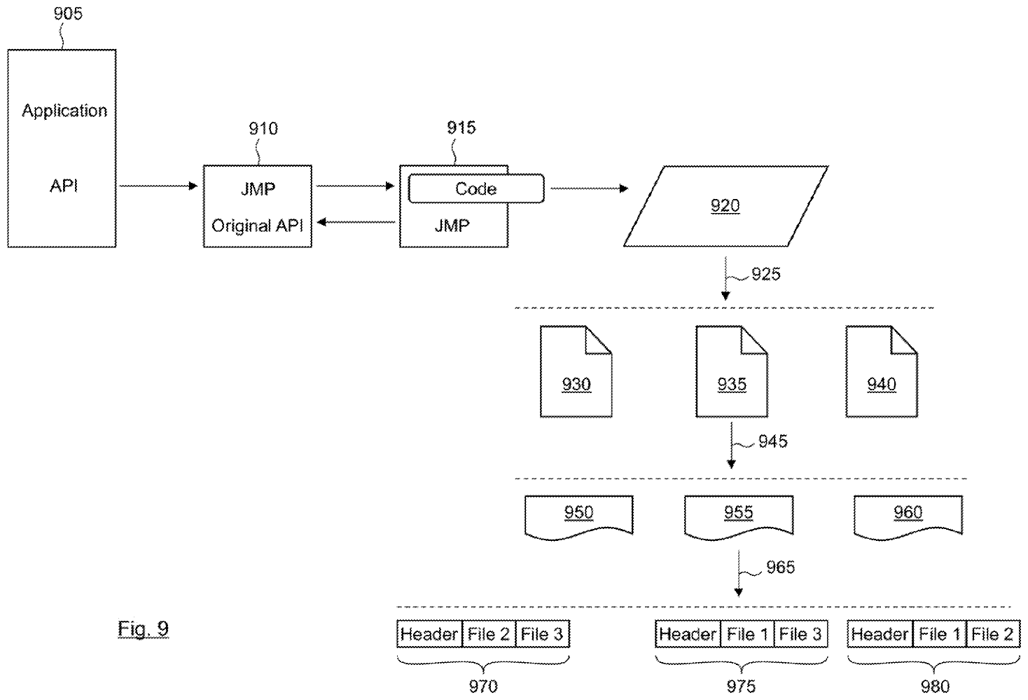

FIG. 9 depicts a method for scanning a file system operation and updating metadata of untrusted files according to an example. When a file system operation is executed on the computing device, the computing device may scan the file system operation as described above. The computing device may scan file system operations by intercepting shell commands, intercepting API calls 905, intercepting shell commands 910, and intercepting kernel mode operations 915, or a combination thereof. Intercepting API calls 905 may include reading and analyzing logs of network protocols used on the computing device and reading and analyzing performed HTTP requests. Intercepting shell commands 910 may for example include reading and analyzing a call stack of the computing device or halting shell commands with a trap or stop function to read and analyze a command. Intercepting kernel mode operations 915 may be similar to intercepting shell commands, but for reading and analyzing commands executed in administrator or kernel mode on the computing device. As described above, a file system operation may include a copy operation, a paste operation, a move operation, or a combination thereof.

The computing device detects 920 a file system operation, for example a call to extract files from an archive file, executing on the computing device. As described above, the computing device may bind the extracted files together and may, in response to determining that no malicious behavior appeared from the file extraction command, write 925 the extracted files on a disk of the computing device. This results in file 1 930, file 2 935, and file 3 940 being extracted from the archive file and written 925 on the disk of the computing device. As also described further above, the associations between file 1 930, file 2 935, and file 3 940 may be stored in respective metadata portion 950 of file 1 930, metadata portion 955 of file 2 935, and metadata portion 960 of file 3 940. Upon a further file system operation being detected by the computing device, the respective metadata portions may be updated 945 according to the further file system operation. This may include updating 965 file association 970 of file 1, file, association 975 of file 2, and file association 980 of file 3. As can be taken from FIG. 9, association 970 of file 1 930 comprises a header, file 2 and file 3. Likewise, the association 975 of file 2 935 comprises a header, file 1 and file 3. In the same manner as described before, association 980 of file 3 940 comprises a header, file 1 and file 2. This way, metadata of associated files may be maintained upon detecting further file system operations involving file 1 930, tile 2 935, file 3 940, or a combination thereof.

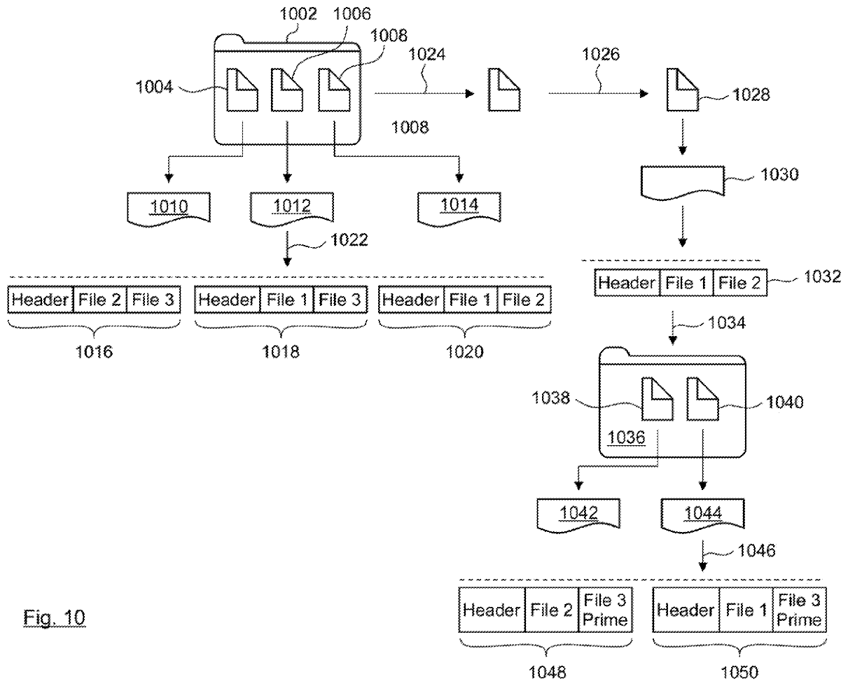

FIG. 10 depicts a method for detecting a file system operation and updating metadata of an untrusted file according to another example. A directory 1002 may be a folder extracted from an archive file, containing three untrusted files, namely file 1 1004, file 2 1006, and file 3 1008. The extraction may be performed as described above. File 1 1004 comprises metadata portion two, file 2 1006 comprises metadata portion 1012 and file 3 1008 comprises metadata portion 1014. The respective metadata portions of the files may comprise file associations to other files as described further above. In the specific example depicted in FIG. 10, file association 1016 of file 1 1004 comprises a header, file 2, and file 3. Respectively, file association 1018 of file 2 1006 comprises a header, file 1, and file 3. In the same manner, file association 1020 of file 3 1008 comprises a header, file 1, and file 2. The file associations 1016, to18, and 1020 may be created 1022 based on the respective metadata portions of the files, namely metadata portion low of file 1, metadata portion 1012 of file 2, and metadata portion1014 of file 3.

A user input 1024 may be received to move file 3 1008 to another storage location on the computing device. This way, file 3 1008 becomes file 3 prime 1028. The metadata of file 3 prime may then be parsed 1026. This may include updating the metadata portion 1030 of file 3 prime 1028 as well as updating 1034 the association list 1032 of file 3 prime 1028.

Updating 1034 the association list 1032 of file 3 prime 1028 may comprise updating the metadata portion 1042 of file 1 1038 comprised in the association list 1032 of file 3 prime 1038. Furthermore, updating 1034 the association list 1032 of file 3 prime 1028 may comprise updating the metadata portion 1044 of file 2 1036 comprised in the association list 1032 of file 3 prime 1028. This may result in a file association 1048 for file comprising a header, file 2, and file 3 prime. Accordingly, this may further result in a file association 1050 of file 2 comprising a header, file 1, and file 3 prime. The file associations may be created 1046 based on the respective metadata portions of the files, namely metadata portion 1042 for file 1 1038 and metadata portion 1044 for file 2 1040. This way, the computing device remains able to open all associated files in the micro VM together with the executed file even though the associated files have been moved to a different storage location on the computing device.

The description is not intended to be exhaustive or limiting to any of the examples described above. The computing device and the non-transitory computer readable storage medium disclosed herein can be implemented in various ways and with many modifications without altering the underlying basic properties.

1. A computing device, comprising:
memory to store a first untrusted file and a second untrusted file; and
a processor to:
scan a file system operation executing on the computing device;
create an association between the first untrusted file and the second untrusted file based on the scanning;
execute the first untrusted file together with the associated second untrusted file in a micro virtual machine (VM); and
identify a malicious behavior of the executed first untrusted file interacting with the associated second untrusted file in the micro VM.

2. The device according to claim 1, wherein the micro VM is to:
virtualize hardware components of the computing device; and
mimic a configuration of the computing device for a specific task, wherein the micro VM has a different kernel than an underlying operating system of the computing device.

3. The device according to claim 1, wherein scanning the file system operations includes intercepting shell commands, intercepting Application Programming Interfaces (APIs), intercepting kernel mode operations of the computing device, or a combination thereof.

4. The device according to claim 1, wherein the file system operation includes a copy operation, a paste operation, a move operation, or a combination thereof.

5. The device according to claim 1, wherein the processor is to maintain the association between the first untrusted file and the second entrusted file when scanning a second file system operation executing on the computing device.

6. The device according to claim 1, wherein the file system operation is assigned a globally unique instance identifier (GUID1), and wherein an association between the first untrusted file and the second untrusted file is associated with the QUID.

7. The device according to claim 1, wherein the association between the first untrusted file and the second untrusted file is stored in a metadata portion of the first untrusted file and in a metadata portion of the second untrusted file.

8. A non-transitory computer-readable storage medium comprising instructions, which when executed by a processor of a computing device, cause the processor to:
receive a user input to open a first untrusted file;
determine an association of the first untrusted file to a second on trusted file;
open the first and second untrusted file in a micro virtual machine (VM); and
identify a malicious behavior of the first and second untrusted file interacting with one another in the micro VM.

9. The storage medium according to claim 8, wherein a malicious behavior comprises an unintended execution of an unrelated task in relation to the first untrusted file, the second untrusted file, or a combination thereof.

10. The storage medium according to claim 9, wherein a malicious behavior comprises:
attempting to perform an unauthorized change to instructions, a folder, a file, and/or a registry entry of the computer,
using disproportionally high processing power in relation to the first untrusted file, the second untrusted file, or a combination thereof.
connecting to an untrusted source,
corrupting hardware of the computing device,
performing ransomware,
or a combination thereof.

11. The storage medium according to claim 9, wherein the instructions when executed further cause the processor to:
determine a source of the malicious behavior from within the first and the second untrusted file; and
reconstruct a file history of the source of the malicious behavior based on associations between the first and the second untrusted

12. The storage medium, according to claim ii. wherein the instructions when executed further cause the processor to generate a notification regarding the reconstructed file history of the source of the malicious behavior.

13. A computing device, comprising:
memory to store a first untrusted file and a second entrusted file; and
a processor to:
redirect an execution operation of the first untrusted file from a host system executing on the computing device to a micro virtual machine (VM);
launch the micro VM to execute the first untrusted file and the second untrusted file;
identify execution of an unrelated task in relation to the first untrusted file, the second untrusted file, or a combination thereof.

14. The device according to claim 13, wherein upon identifying of execution of an unrelated task, the processor is to:
close the micro VM executing the first and second untrusted file; and
mark the first and second untrusted file as not executable by the device.

15. The device according to claim 13, wherein upon identifying no execution of an unrelated task, the processor is to:
mark the first untrusted file as trusted, and
execute the first trusted file directly on the host system of the device.
